(19) United States
(12) Patent Application Publication
(10) Pub. No.: US 2012/0289073 A1
(43) Pub. Date: Nov. 15, 2012

(54) POWER ADAPTER WITH A CHANGEABLE PLUG

(75) Inventors: Wei-Ken Wu, Taipei City (TW); Ching-Chih Chou, Taipei City (TW); Shou-Tang Hsieh, Taipei City (TW)

(73) Assignee: Atech OEM Inc.

(21) Appl. No.: 13/106,901

(22) Filed: May 13, 2011

(51) Int. Cl. H01R 27/00

(52) U.S. Cl. 439/218

(57) ABSTRACT

A power adapter includes a main body, electrical conductive terminals provided in the main body, and a plug. The plug includes a base, a first insertion piece and a second insertion piece. A first side of the base is formed with first directional grooves, and a second side thereof is formed with second directional grooves. The first insertion piece is provided with first insertion portions. The second insertion piece is provided with second insertion portions. The first side or second side of the plug penetrates the main body. The first insertion portion and the second insertion portion press the electrical conductive terminals, so that the first insertion piece and the second insertion piece are electrically connected with the electrical conductive terminals respectively. By this structure, the direction for the plug being inserted into a power socket can be changed based on practical demands.

### BACKGROUND OF THE INVENTION

1. Field of the Invention

The present invention relates to a power adapter, and in particular to a power adapter with a changeable plug.

2. Description of Prior Art

More and more electronic apparatuses are widely used in our daily life or work, such as computers, digital cameras, mobile phones or the like. When these electronic apparatuses are charged or electrically connected with a power source, a power adapter is often required.

The aforesaid power adapter includes a main body and a plug. The main body comprises a base in which circuitry or transforming elements are provided. Thus, the main body has a specific volume. The plug is connected to the main body with a fixed angle. If the direction in which the plug is inserted into a power socket is different from the orientation of electrical wires of the plug, or if the location of an electronic appliance (such as a vacuum cleaner or electric tool) connected to the power adapter has to be changed, the connecting portion of the electrical wires and the main body may be subjected to a twisting force. As a result, the electrical wires may disorder and even break, which causes short circuit of the electrical wires and even a possible fire accident.

In view of the above, the present Inventor proposes a novel and reasonable structure to solve the problems in prior art based on his expert knowledge and deliberate researches.

### SUMMARY OF THE INVENTION

The present invention is to provide a power adapter with a changeable plug, whereby the direction for the plug being inserted into a power socket can be changed based on practical demands, thereby increasing its convenience in use.

The present invention provides a power adapter with a changeable plug, which includes a main body, a pair of electrical conductive terminals, and a plug. The main body has an electrical conductive space. The electrical conductive terminals are disposed in the main body to protrude into the electrical conductive space. The plug comprises a base, a first insertion piece and a second insertion piece provided on the base. The base has an insertion space, a first side and a second side located around the insertion space. The base is formed on the first side with a set of first directional grooves extending toward the insertion space. The base is formed on the second side with a set of second directional grooves extending toward the insertion space. The first insertion piece is provided with a first insertion portion at the bottom of one of the first directional grooves and another first insertion portion at the bottom of one of the second directional grooves. The second insertion piece is provided with a second insertion portion at the bottom of the other first directional groove and another second insertion portion at the bottom of the other second directional groove. The first side or second side of the plug penetrates the electrical conductive space of the main body. The first insertion portion and the second insertion portion press the electrical conductive terminals, so that the first insertion piece and the second insertion piece are electrically connected to the electrical conductive terminals respectively.

In comparison with prior art, according to the plug of the present invention, the first side of the base is formed with a set of first directional grooves, and the second side of the base is formed with a set of second directional grooves. Thus, the first side or the second side of the plug can penetrates the electrical conductive space of the main body in such a manner that the first insertion piece and the second insertion piece are electrically connected to the electrical conductive terminals of the main body respectively. In this way, the direction for the plug being inserted into a power socket can be changed based on practical demands, thereby preventing electrical wires from twisting or breaking and in turn preventing short circuit of the electrical wires or a fire accident. Therefore, the convenience and safety of the present invention are increased.

### BRIEF DESCRIPTION OF DRAWING

FIG. 1 is an exploded schematic view of the present invention;

FIG. 2 is a plan view showing the plug of the present invention;

FIG. 3 is a perspective view of the present invention showing that the plug is located in one insertion direction;

FIG. 4 is a cross-sectional schematic view (I) of the present invention;

FIG. 5 is a cross-sectional schematic view (II) of the present invention;

FIG. 6 is an exploded perspective view of the present invention showing that the plug is located in another insertion direction;

FIG. 7 is a perspective view of the present invention showing that the plug is located in another insertion direction; and

FIG. 8 is a cross-sectional view of the present invention showing that the plug is located in another insertion direction.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

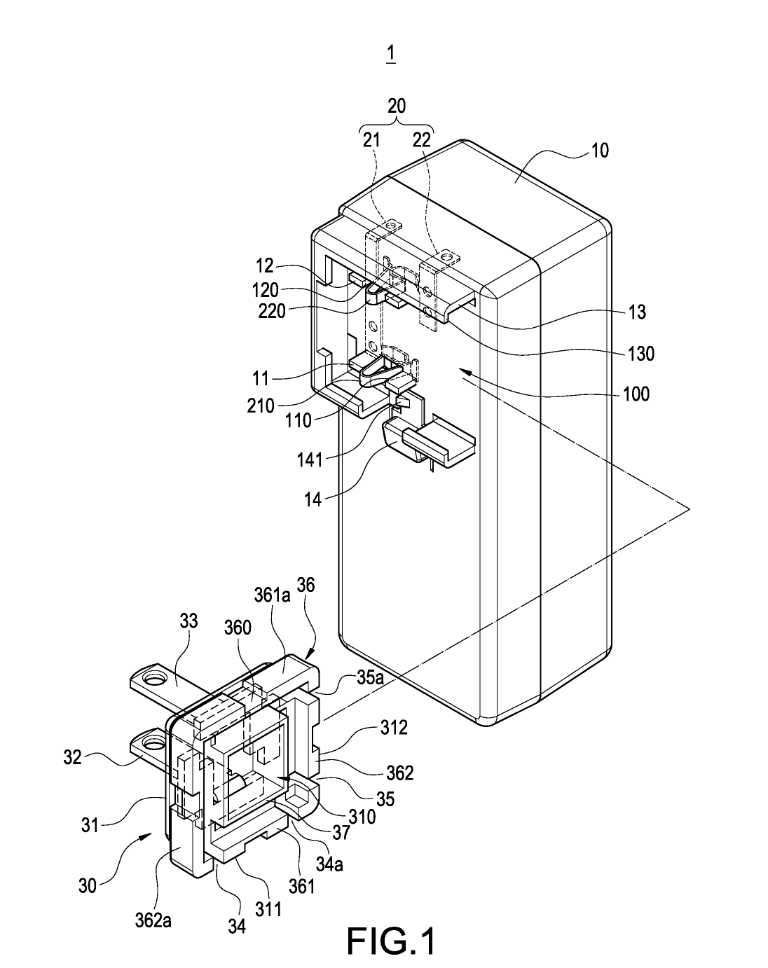

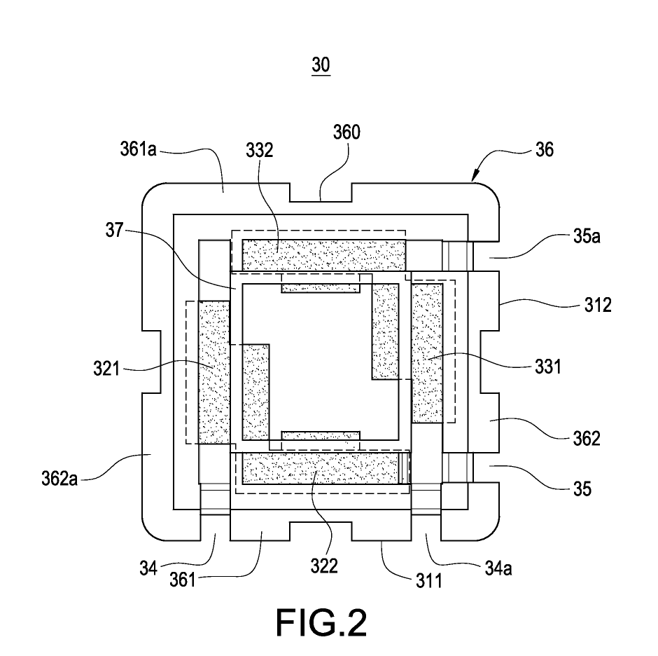

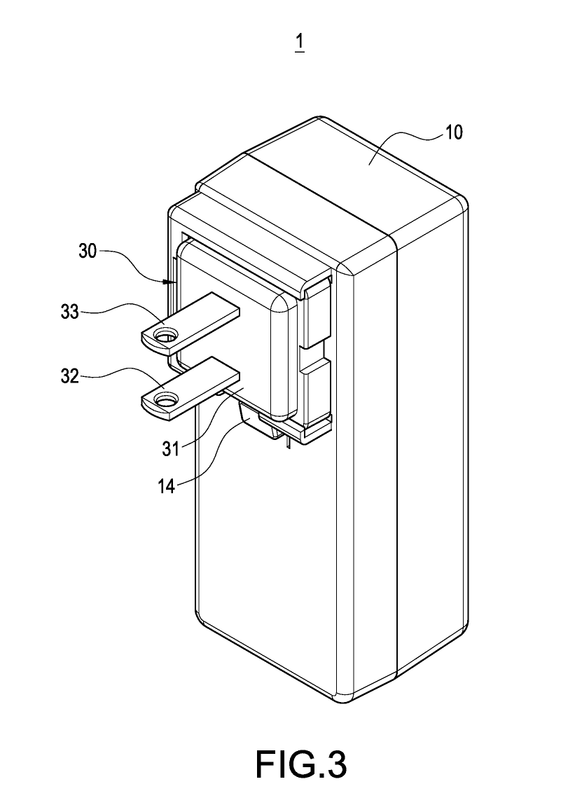

FIG. 1 is an exploded schematic view of the present invention. FIG. 2 is a plan view showing the plug of the present invention. FIG. 3 is a perspective view of the present invention showing that the plug is located in one insertion direction. The present invention provides a power adapter 1 with a changeable plug, which includes a main body 10, a pair of electrical conductive terminals 20, and a plug 30 disposed on the main body 10.

The main body 10 has an electrical conductive space 100. The main body 10 is formed in the electrical conductive space 100 with a first guiding rail 11 and a second guiding rail 12 in parallel to the first guiding rail 11. A middle section of the first guiding rail 11 is provided with a first notch 110. A middle section of the second guiding rail 12 is provided with a second notch 120. Further, the main body 10 is formed with a stopping plate 13 around the electrical conductive space 100 and a locking arm 14 provided on one side of the stopping plate 13. The locking arm 14 has a stopping block 141. The other side of the stopping plate 13 which is perpendicular to the locking arm 14 is formed with an opening 130 for allowing the plug 30 to penetrate.

The pair of electrical conductive terminals 20 is provided in the main body 10 to protrude into the electrical conductive space 100. The pair of electrical conductive terminals 20 comprises a first electrical conductive terminal 21 and a second electrical conductive terminal 22. The first electrical conductive terminal 21 partially protrudes into the first notch 110, and the second electrical conductive terminal 22 partially protrudes into the second notch 120. In the present embodiment, the portion of the first electrical conductive terminal 21 protruding into the first notch 110 is a first electrical conductive section 210. The first electrical conductive section 210 is formed into a V shape and elastically clamped in the first notch 110. The portion of the second electrical conductive terminal 22 protruding into the second notch 120 is a second electrical conductive section 220. The second electrical conductive section 220 is formed into a V shape and elastically clamped in the second notch 120.

The plug 30 comprises a base 31, a first insertion piece 32 and a second insertion piece 33. The base 31 has an insertion space 310, a first side 311 and a second side 312 located around the insertion space 310. The base 31 is formed on the first side 311 with a set of first directional grooves 34, 34a extending toward the insertion space 310. The base 31 is formed on the second side 312 with a set of second directional grooves 35, 35a extending toward the insertion space 310. The first insertion piece 32 is provided with a first insertion portion 321 at the bottom of the first directional groove 34 and another first insertion portion 322 at the bottom of the second directional groove 35. The second insertion piece 33 is provided with a second insertion portion 331 at the bottom of the other first directional groove 34a and another second insertion portion 332 at the bottom of the other second directional groove 35a.

In the present embodiment, the base 31 is formed with a first surrounding plate 36 outside the insertion space 310. The inside of the first surrounding plate 36 is formed with a second surrounding plate 37 separated from the first surrounding plate 36 by a gap. The second surrounding plate 37 is formed into a square shape, but it is not limited thereto. The first insertion portions 321, 322 and the second insertion portions 331, 332 are disposed between the first surrounding plate 36 and the second surrounding plate 37.

Further, the outer edge of the first surrounding plate 36 corresponds to the locking arm 14 to be provided with a plurality of locking troughs 360. The first surrounding plate 36 comprises two opposite first side plates 361, 361a and two opposite second side plates 362, 362a. The set of first directional grooves 34, 34a are provided on the first side plate 361 without penetrating the other first side plate 361a. The set of second directional grooves 35, 35a are provided on the second side plate 362 without penetrating the other second side plate 362a.

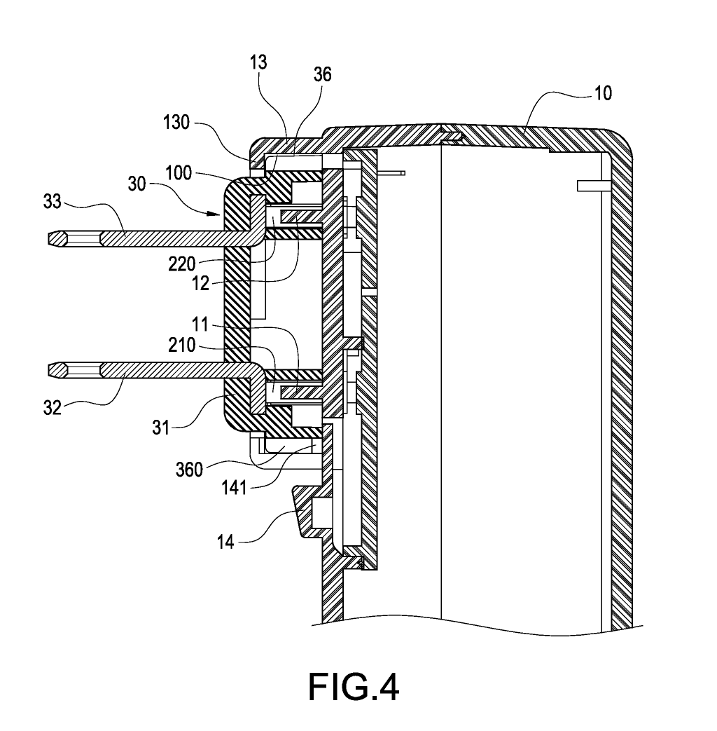

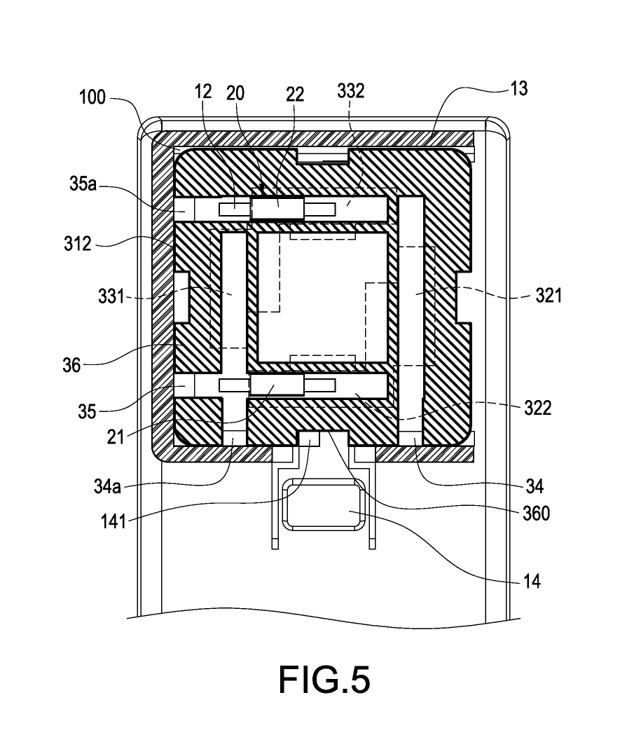

FIG. 4 is a cross-sectional schematic view (I) of the present invention. FIG. 5 is a cross-sectional schematic view (II) of the present invention. When the power adapter 1 of the present invention is in use, the plug 30 is inserted onto the main body 10. The second side 312 of the plug 30 penetrates the electrical conductive space 100 of the main body 10 as shown in FIG. 1. At this time, the first insertion portion 322 and the second insertion portion 332 located in the second directional grooves 35, 35a press the first electrical conductive terminal 21 and the second electrical conductive terminal 22 respectively, so that the first insertion piece 32 and the second insertion piece 33 are electrically connected to the pair of electrical conductive terminals 20 respectively. After the plug 30 is completely inserted into the electrical conductive space 100, the outer wall of the first surrounding plate 36 abuts against the inner wall of the stopping plate 13. The stopping block 141 of the locking arm 14 abuts against the wall surface of one of the locking troughs 360.

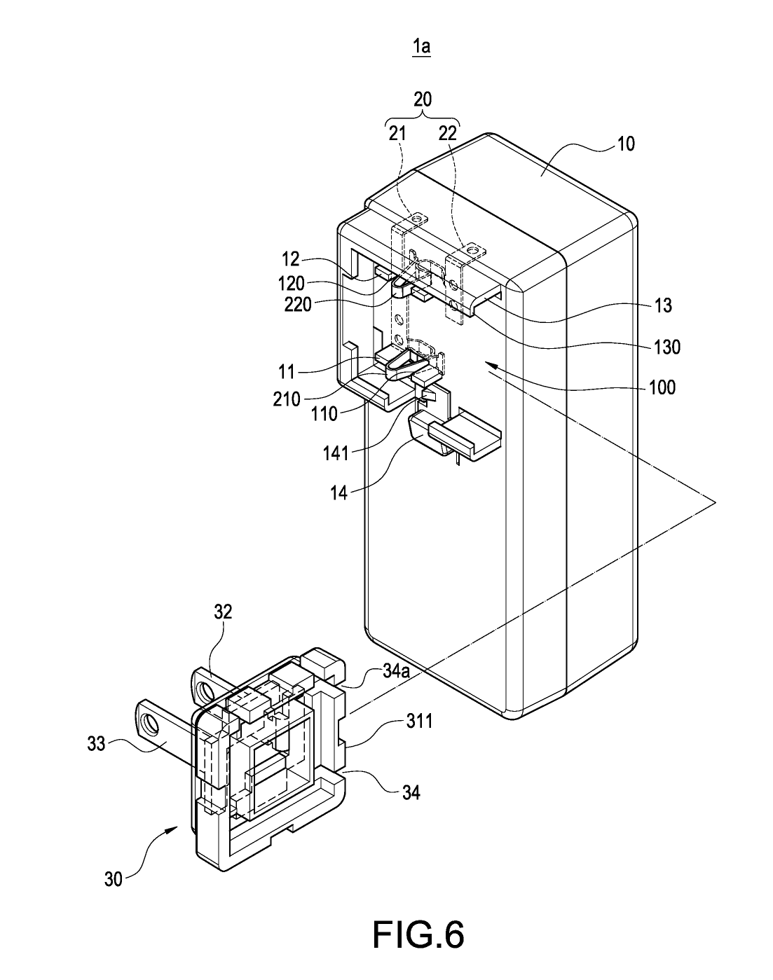

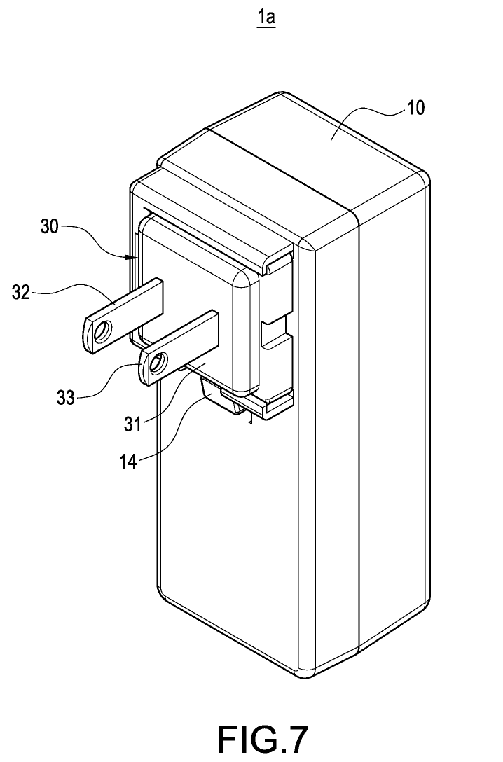

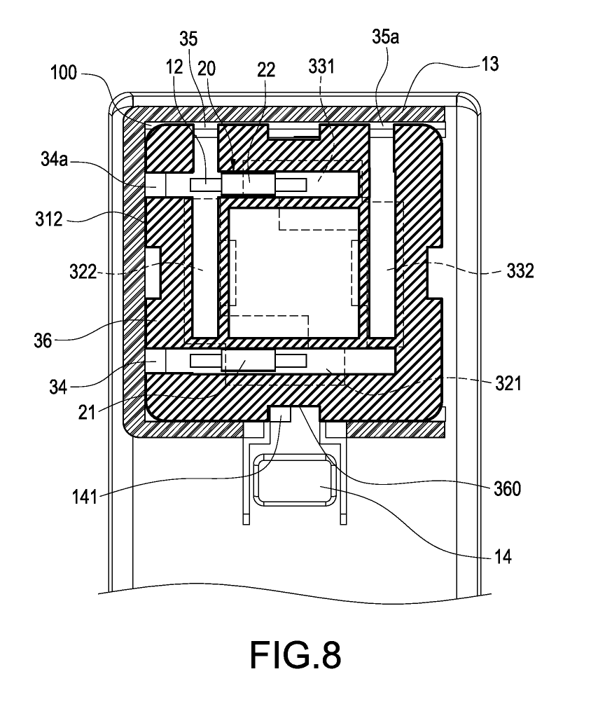

FIG. 6 is an exploded perspective view of the present invention showing that the plug is located in another insertion direction. FIG. 7 is a perspective view of the present invention showing that the plug is located in another insertion direction. FIG. 8 is a cross-sectional view of the present invention showing that the plug is located in another insertion direction. It can be seen from FIG. 6 that the first side 311 of the plug 30 penetrates the electrical conductive space 100 of the main body 10. The first insertion portion 321 and the second insertion portion 331 located in the first directional grooves 34, 34a press the first electrical conductive terminal 21 and the second electrical conductive terminal 22, so that the first insertion piece 32 and the second insertion piece 33 are electrically connected to the pair of electrical conductive terminals 20 respectively.

By the above-mentioned structure, the user can adjust the orientation of the plug 30 on the main body 10 based on practical demands. Thus, the direction for the plug 30 being inserted into a power socket can be changed.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A power adapter with a changeable plug, including:
a main body having an electrical conductive space;
a pair of electrical conductive terminals disposed in the main body to protrude into the electrical conductive space; and
a plug comprising a base, a first insertion piece and a second insertion piece provided on the base, the base having an insertion space, a first side and a second side located around the insertion space, the base being formed on the first side with a set of first directional grooves extending toward the insertion space, the base being formed on the second side with a set of second directional grooves extending toward the insertion space, the first insertion piece being provided with a first insertion portion at the bottom of one of the first directional grooves and another first insertion portion at the bottom of one of the second directional grooves, the second insertion piece being provided with a second insertion portion at the bottom of the other first directional groove and another second insertion portion at the bottom of the other second directional groove;
wherein the first side or the second side of the plug penetrates the electrical conductive space of the main body, the first insertion portion and the second insertion portion press the electrical conductive terminals, so that the first insertion piece and the second insertion piece are electrically connected to the electrical conductive terminals respectively.

2. The power adapter with a changeable plug according to claim 1, wherein the body is formed in the electrical conductive space with a first guiding rail and a second guiding rail in parallel to the first guiding rail, a middle section of the first guiding rail is provided with a first notch, a middle section of the second guiding rail is provided with a second notch.

3. The power adapter with a changeable plug according to claim 2, wherein the pair of electrical conductive terminals comprises a first electrical conductive terminal and a second electrical conductive terminal, the first electrical conductive terminal partially protrudes into the first notch, the second electrical conductive terminal partially protrudes into the second notch.

4. The power adapter with a changeable plug according to claim 3, wherein a portion of the first electrical conductive terminal protruding into the first notch is a first electrical conductive section, the first electrical conductive section is formed into a V shape and elastically clamped in the first notch, a portion of the second electrical conductive terminal protruding into the second notch is a second electrical conductive section, the second electrical conductive section is formed into a V shape and elastically clamped in the second notch,

5. The power adapter with a changeable plug according to claim 1, wherein the main body is formed with a stopping plate around the electrical conductive space and a locking arm provided on one side of the stopping plate, the locking arm has a stopping block, the other side of the stopping plate which is perpendicular to the locking arm is formed with an opening for allowing the plug to penetrate.

6. The power adapter with a changeable plug according to claim 5, wherein the base is formed with a first surrounding plate outside the insertion space, an outer edge of the first surrounding plate corresponds to the locking arm to be provided with a plurality of locking notches.

7. The power adapter with a changeable plug according to claim 6, wherein an outer wall of the first surrounding plate abuts against an inner wall of the stopping plate, the stopping block abuts against a wall surface of one of the locking troughs.

8. The power adapter with a changeable plug according to claim 6, wherein the first surrounding plate comprises two opposite first side plates and two opposite second side plates, the set of first directional grooves are provided on one of the first side plates without penetrating the other first side plate, the set of second directional grooves are provided on one of the second side plates without penetrating the other second side plate.

9. The power adapter with a changeable plug according to claim 6, wherein the base is further formed with a second surrounding plate inside the first surrounding plate, the second surrounding plate is separated from the first surrounding plate by a gap, the first insertion portions and the second insertion portions are disposed between the first surrounding plate and the second surrounding plate.
